(19) United States
(12) Patent Application Publication
(10) Pub. No.: US 2025/0273002 A1
(43) Pub. Date: Aug. 28, 2025

(54) TABLE STRUCTURE RECOGNITION USING OPTIMAL TRANSPORT

(71) Applicant: INTERNATIONAL BUSINESS MACHINES CORPORATION, ARMONK, NY (US)

(72) Inventors: Ran Kimura, Kawasaki (JP); Shoko Suzuki, Yokohama-shi (JP)

(21) Appl. No.: 18/589,376

(22) Filed: Feb. 27, 2024

(51) Int. Cl. G06V 30/412; G06V 10/82

(52) U.S. Cl. CPC G06V 30/412; G06V 10/82

(57) ABSTRACT

A computer-implemented method receives a first table and a second table into a table evaluation system. Each of a plurality of cells of the first table and the second table are converted into a two-dimensional point with a cell weight related to the size of the cell. An edit distance matrix is computed between the cells of the first table and the cells of the second table, where the edit distance matrix being obtained is based on contents of cells. An optimal transport distance matrix is calculated between the cells of the first table and the cells of the second table by using the two-dimensional point and the cell weight for each of the plurality of cells. An output is generated that indicates a correspondence between cells in the first table and cells in the second table by using the edit distance matrix and the optimal transport distance matrix.

### BACKGROUND

The present disclosure generally relates to systems and methods for providing an evaluation metric for table structure recognition (TSR), and more particularly, to an evaluation metric for TSR that uses optimal transport to compare predicted cells with gold cells.

Table structure recognition (TSR) is a task that analyzes tables in digital documents and identifies the cell locations in each table. Since tables include rich information in various kinds of documents including financial documents, invoices, and scientific papers, TSR plays an important role in making the structure of a table machine-understandable so that many downstream tasks such as question answering, knowledge graph construction, and information extraction can benefit from it. A typical TSR system consumes an image that corresponds to a single table in a document and outputs a two-dimensional cell structure in the form of html or json.

Although TSR seems well-defined as a task of artificial intelligence, it is still challenging how to evaluate the output of a TSR system given the gold structure (e.g., ground truth of the cell structure of the input table) due to the difficulty in defining unambiguous ground truth and penalties for discrepancies between the ground truth and the prediction result. The simplest method that compares gold and prediction cells based on their absolute positions improperly gives low scores to the prediction because a single error of a cell results in all subsequent cells being out of position by one.

To address this problem, several metrics have been proposed that use the relative positions of the predicted cells in the whole structure of a table. However, none of these methods explicitly tells where the difference is between the gold and predicted cells because they just return a single numerical value, usually a real number in [0, 1] which indicates the degree of correctness of the prediction. This makes it difficult to leverage the result of evaluation to analyze the weakness of the TSR system and to improve it.

### SUMMARY

In one embodiment, a system and method are described that provide an evaluation metric for TSR, denoted herein as TabOT, that uses optimal transport to compare predicted cells with gold cells. TabOT visualizes the matching between gold cells and prediction cells. Information on which cells fail in matching is useful for model improvement. Scores of the metric are positively correlated with conventional methods, such as grid table similarity (GriTS) and tree edit distance-based similarity (TEDS) scores, and can replace existing metrics. Unlike existing metrics, TabOT is symmetric with row/column deletion operations and gold/prediction table replacement. This indicates that TabOT can be used to measure the similarity between two tables intuitively.

Existing evaluation metrics of TSR are typically used to measure the performance of a TSR system and to compare multiple systems. However, they do not give any insight into what causes the performance degradation of a system because their output is usually a single number that indicates the degree of correctness of recognition. In addition to such a global numerical indicator. TabOT can provide a visual representation of differences in structure between cells predicted by the system and gold cells of a table which is intuitive to human interpretation. It would help analyze the weakness of the TSR system and improve it. Specifically, the problem of TSR evaluation is formulated as an optimal transport problem to minimize the cost of moving weights of cells between gold and prediction table structures. This gives an explicit mapping between cells in gold structure and those in prediction from which one can understand large discrepancies there between.

In one embodiment, a computer-implemented method for comparing tables receives a first table and a second table into a table evaluation system. Each of a plurality of cells of the first table and the second table are converted into a two-dimensional point with a cell weight related to the size of the cell. An edit distance matrix is computed between the cells of the first table and the cells of the second table, where the edit distance matrix being obtained based on contents of cells. An optimal transport distance matrix is calculated between the cells of the first table and the cells of the second table by using the two-dimensional point and the cell weight for each of the plurality of cells. An output is generated that indicates a correspondence between cells in the first table and cells in the second table by using the edit distance matrix and the optimal transport distance matrix.

In another embodiment, a computer-implemented method for evaluating a table structure recognition model, and a related software product that is configured to cause a computer to perform the computer-implemented method includes receiving a prediction table into a table structure recognition evaluation system by using a table structure recognition model. A ground truth table, representing a ground truth of the first table, is also received into the table structure recognition evaluation system. Each of a plurality of cells of the prediction table and the ground truth table are converted into a two-dimensional point with a cell weight related to the size of the cell. An edit distance matrix between the cells of the prediction table and the cells of the ground truth table is computed, where the edit distance matrix being obtained based on contents of cells. An optimal transport distance matrix between the cells of the prediction table and the cells of the ground truth table is calculated by using the two-dimensional point and the cell weight for each of the plurality of cells. An output is generated that indicates a correspondence between cells in the prediction table and cells in the ground truth table by using the edit distance matrix and the optimal transport distance matrix.

In another embodiment, a computer-implemented method for providing a metric for the evaluation of table structure recognition model includes receiving a prediction table into a table structure recognition evaluation system by using a table structure recognition model. A ground truth table, representing a ground truth of the first table, is also received into the table structure recognition evaluation system. Each of a plurality of cells of the prediction table and the ground truth table are converted into a two-dimensional point with a cell weight related to the size of the cell. An edit distance matrix between the cells of the prediction table and the cells of the ground truth table is computed, where the edit distance matrix being obtained based on contents of cells. An optimal transport distance matrix between the cells of the prediction table and the cells of the ground truth table is computed by using the two-dimensional point and the cell weight for each of the plurality of cells. A ground cost, also referred to as a ground overhead value, is calculated by using the optimal transport distance matrix and the edit distance matrix. An evaluation metric, based on the ground overhead value, is calculated and outputted, indicating a degree of matching between the first table and the second table.

In another embodiment, a system includes a processor, a data bus coupled to the processor, a memory coupled to the data bus, and a computer-usable medium embodying a computer program code, the computer program code comprising instructions executable by the processor. The computer program code is configured to receive a first table and a second table into a table evaluation system and convert each of a plurality of cells of the first table and the second table into a two-dimensional point with a cell weight related to the size of the cell. The computer program code can compute an edit distance matrix between the cells of the first table and the cells of the second table, where the edit distance matrix being obtained based on contents of cells. The computer program code can further compute an optimal transport distance matrix between the cells of the first table and the cells of the second table by using the two-dimensional point and the cell weight for each of the plurality of cells. An output is generated that indicates a correspondence between cells in the first table and cells in the second table by using the edit distance matrix and the optimal transport distance matrix.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A shows how cell position (center of gravity) and weights are defined for a table, consistent with an illustrative embodiment;

FIG. 1B shows an overview of an optimal transport evaluation of the table structure, consistent with an illustrative embodiment;

FIG. 2 illustrates an evaluation of cell matching with methods consistent with an illustrative embodiment, where the values below the graph are the number of cells with correct matching/manually matched cells;

FIG. 3A illustrates a table showing a gold table used in a method, consistent with an illustrative embodiment;

FIG. 3B illustrates a table showing a prediction table, based on the gold table of FIG. 3A, used in a method, consistent with an illustrative embodiment;

FIG. 3C illustrates a graphical representation of cell matching between the gold table of FIG. 3A and the prediction table of FIG. 3B, consistent with an illustrative embodiment;

FIG. 4A illustrates a table showing a gold table used in a method consistent with an illustrative embodiment;

FIG. 4B illustrates a table showing a prediction table, based on the gold table of FIG. 4A, used in a method consistent with an illustrative embodiment;

FIG. 4C illustrates a graphical representation of cell matching between the gold table of FIG. 4A and the prediction table of FIG. 4B, including the effect of combining optimal transport and edit distance, consistent with an illustrative embodiment;

FIG. 5A illustrates a graph showing a relationship between TabOT, consistent with an illustrative embodiment, and TEDS;

FIG. 5B illustrates a graph showing a relationship between TabOT, consistent with an illustrative embodiment, and GriTS;

FIG. 6A illustrates a bar graph showing scores for TSR evaluation of financial report tables (FinTabNet) using a conventional TEDS metric;

FIG. 6B illustrates a bar graph showing scores for TSR evaluation of financial report tables (FinTabNet) using a conventional GriTS metric;

FIG. 6C illustrates a bar graph showing scores for TSR evaluation of financial report tables (FinTabNet) using TabOT, consistent with an illustrative embodiment;

FIG. 7A illustrates a graph showing the relationship between the number of cells in the tables and the scores for TSR evaluation of financial report tables (FinTabNet) using a conventional TEDS metric;

FIG. 7B illustrates a graph showing the relationship between the number of cells in the tables and the scores for TSR evaluation of financial report tables (FinTabNet) using a conventional GriTS metric;

FIG. 7C illustrates a graph showing the relationship between the number of cells in the tables and the scores for TSR evaluation of financial report tables (FinTabNet) using TabOT, consistent with an illustrative embodiment;

FIG. 8 shows a flow chart illustrating an overall process for providing an evaluation metric for TSR, consistent with an illustrative embodiment; and

FIG. 9 is a functional block diagram illustration of a computer hardware platform that can be used to implement the method for providing an evaluation metric for TSR, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can provide an evaluation metric for a table structure recognition that can provide not only a numerical value that indicates the degree of correctness of recognition but also a visual representation of differences in structure between cells predicted by a TSR system and gold cells of a table.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide an evaluation metric for TSR. This may have the technical effect of providing not only a global numerical indicator that indicates the degree of correctness of table structure recognition, but also a visual representation of differences in structure between cells precited by the system and gold cells of a table, which is intuitive to human interpretation. Accordingly, the system and methods according to aspects of the present disclosure provide a substantial improvement to technology and computer functionality.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

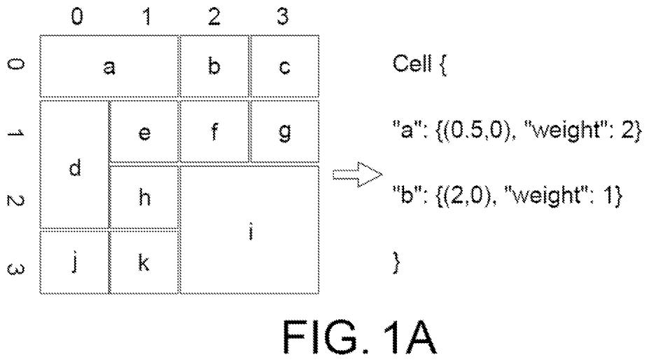

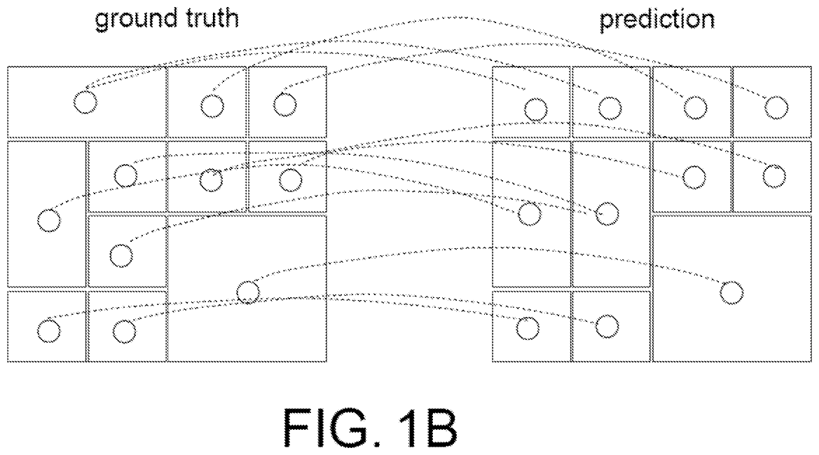

Aspects of the present disclosure provide table cell optimal transport using figures and equations. In optimal transport, it requires point clouds (locations of points and materials to be transported) to be defined. In table optimal transport, each cell is replaced by a point cloud. FIG. 1 shows a point cloud representation of cells. Cell locations and cell weights are defined, where (x, y) coordinates define a center of gravity of a cell and a cell weight is provided based on the size of the cell. For example, cell “a” has a location of (0.5, 0) and a cell weight of 2, while cell “b” has a location of (2, 0) and a cell weight of 1, and cell “i” has a location of (2.5, 2.5) and a weight of 4. The location of cell can be referred to as cell gravity. In some embodiments, the cell weight can be further based on a predetermined importance of the content of the cells.

Table optimal transport is transport and matching cells as illustrated in FIG. 1B. This shows a structure metric of TabOT, and text information can be used to calculate a content metric, as described in greater detail below.

The cells of gold and prediction tables can be defined as two-dimensional point clouds X={xᵢ}ᵢ₌₁ⁿ and [symbol] ={yⱼ}ⱼ₌₁^{m}, where n is the maximum number of columns in the table and m is the maximum number of rows in the table. The definition is performed by taking the coordinates of the center of the cell, as discussed above with respect to FIG. 1A.

A histogram Σ_{N} can be defined with N bins with p∈ [symbol] ₊^{N}, Σᵢₚ_{ᵢ}=1. Two empirical distributions (p, q) can be assumed, with (p, q)∈Σₙ×Σₘ for X, [symbol] follows:

$$\begin{matrix}p = {\sum }_{i - 1}^{n} {p}_{i} {δ}_{{x}_{i}} , & q = {\sum }_{j = 1}^{m} {q}_{j} {δ}_{{y}_{j}}\end{matrix} \qquad ( 1 )$$

where pᵢ and qⱼ are cell weights and δ is the Dirac function.

Since, in some situations, there are cells that do not transport, a partial optimal transport can be used for cell transport. Consider the case where n=m. For example, there are cases where two tables are recognized as one table or only a part of a table is recognized. In such cases, the overflow cell should not match anywhere in the other cell. This condition applies to the idea of partially optimal transport, where all cells are not matched against each other. Only the smaller number of cells in the table of gold or predictions, s=min(∥p∥₁, ∥q∥₁), should be matched.

In that case, the set of admissible couplings is as follows:

$${\prod }^{u} ( p , q ) = \{ T ∈ {ℝ}_{+}^{\vert p \vert x \vert q \vert} {\vert T 1 \vert}_{\vert q \vert} \leq p , {T}^{⊤} {1}_{\vert p \vert} \leq q , {1}_{\vert p \vert}^{⊤} T {1}_{\vert q \vert} = s \} \qquad ( 2 )$$

where T=Tᵢⱼ is a coupling matrix with an entry Tᵢⱼ that represents how the weight pᵢ of xᵢ is transported to the weight qⱼ of yⱼ.

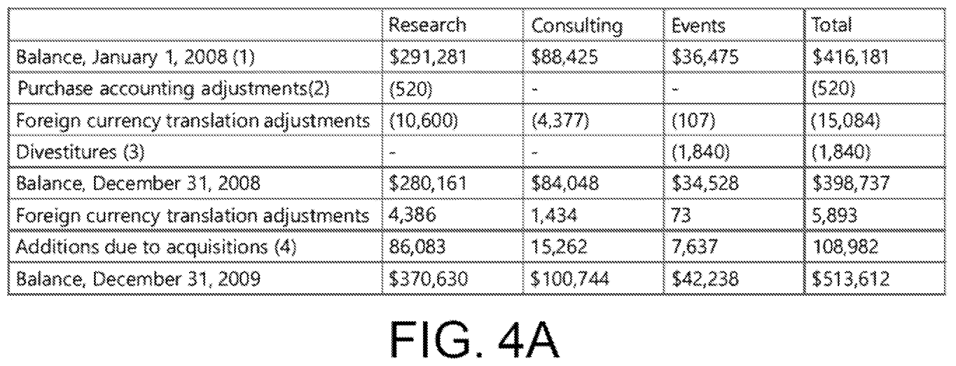

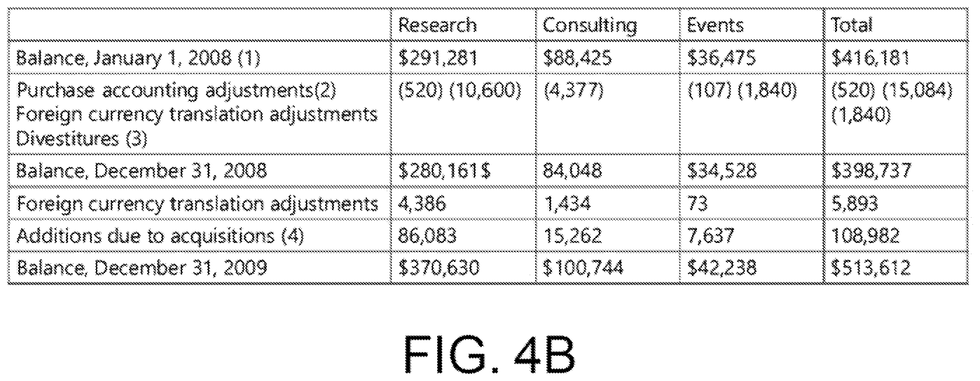

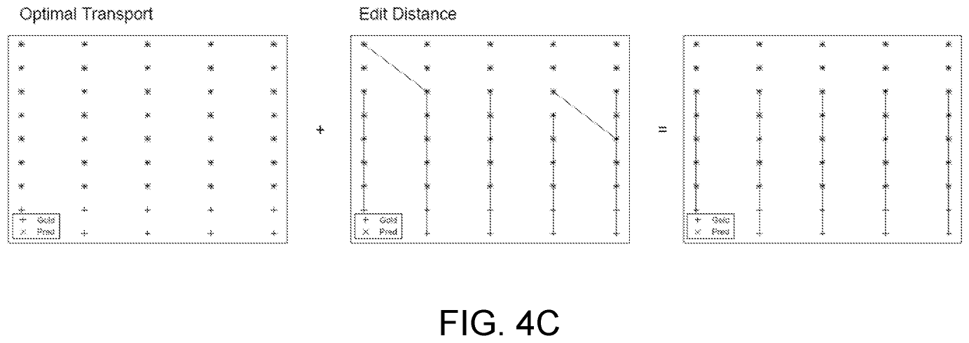

For each point, the cell optimal transport distance matrix Dₒₜ is computed for position and the edit distance matrix Dₜₑₓₜ for cell contents. In this experiment, Dₒₜ is the Euclidean distance and Dₜₑₓₜ is the Levenshtein distance. Other distance measures can also be used. In this experiment, each distance is normalized. The ground overhead value C is represented below:

$$C = {aD}_{ot} + ( 1 - a ) {D}_{text} \qquad ( 3 )$$

where a is a parameter that can be adjusted to determine a weighting ratio of the edit distance to the distance of the point cloud and C is normalized. In this experiment, a=0.5 was used. Like existing metrics, such as TEDS and GriTS, TabOT can measure both structure and content score. When a=1, this represents the structure score, and when a=0, the content score. Integrating two distances provides a more accurate measure of cell matching, as discussed below with respect to FIGS. 4A through 4C. In some embodiments, methods of the present disclosure can output a graphical representation illustrating a combined result of the optimal transport distance matrix and the edit distance matrix. In some embodiments, the ground overhead value can be used not only for evaluation of the TSR model, but also as an objective function for retraining the table structure recognition model, and can contribute to both performance improvement and correct evaluation.

The partial optimal transport, which does not transport all the cells in the table, is the optimization problem of the partial Wasserstein distance. The partial Wasserstein distance is described as follows:

$${PW}_{p}^{p} ( p , q ) = {min}_{T ∈ {Π}^{u} ( p , q )} {〈 C , T 〉}_{F} = {min}_{T ∈ {Π}^{u} ( p , q )} {\sum }_{i = 1}^{n} {\sum }_{j = 1}^{m} {C}_{ij} {T}_{ij} \qquad ( 4 )$$

The penalty for cells that are not transported can be considered. The difference in the number of cells in the two tables is not transported in the formulation. When there are many cells that are not transported, the penalty is large, because this is when the form of the gold and prediction tables are significantly different. The penalty N M(p, q) of non-matching cells is represented as follows:

$$N M ( p , q ) = \frac{max ( {‖ p ‖}_{1} , {‖ q ‖}_{1} ) - min ( {‖ p ‖}_{1} , {‖ q ‖}_{1} )}{max ( {‖ p ‖}_{1} , {‖ q ‖}_{1} )} , \qquad ( 5 )$$

where max(∥p∥₁, ∥q∥₁) is the coefficient for normalization.

The evaluation metric O is shown in the following equation:

$$O = 1 - \frac{( \frac{{PW}_{p}^{p} ( p , q )}{min ( {‖ p ‖}_{1} , {‖ q ‖}_{1} )} + N M ( p , q ) )}{2} , \qquad ( 6 )$$

Since PWₚ^{p}(p,q)/min(∥p∥₁,∥q∥₁) is in [0, 1] and N M(p, q) also ranges in [0, 1], O takes the range zero to one. TEDS also takes values less than zero, while TabOT, according to aspects of the present disclosure, takes the range [0, 1]. TabOT thus has a fixed lower limit and is easy to handle as an evaluation metric.

### Cell Matching Correctness

In this section, the accuracy of matching gold and prediction cells using the evaluation metric TabOT is shown. TabOT is capable of explicit cell matching, which existing evaluation metrics such as TEDS and GriTS cannot perform. Aspects of the present disclosure can show, visually, how the cells are matched.

For the below described experiments, 20 pdfs were randomly extracted from FinTabNet, and table structure recognition was performed using an in-house model. FinTabNet is a dataset of financial tables and the in-house model is a detr-based model. The recognized tables were used as prediction tables. Then, cells from the prediction tables were manually matched to the gold tables. Finally, the correct matches were compared with the matches using the evaluation metric.

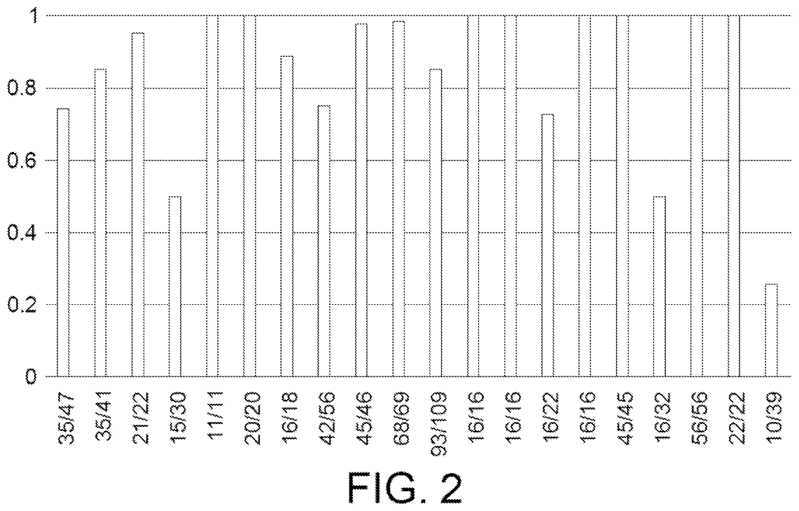

The results for each of the 20 tables are shown in FIG. 2. Of the manually matched cells, 84.20% were correctly matched using TabOT. Since existing methods cannot explicitly map cells, the methods according to the present disclosure are suitable for accurate evaluation of table structure because of its high probability of mapping.

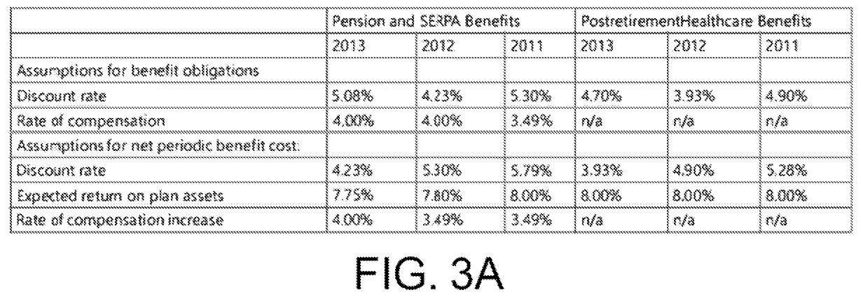

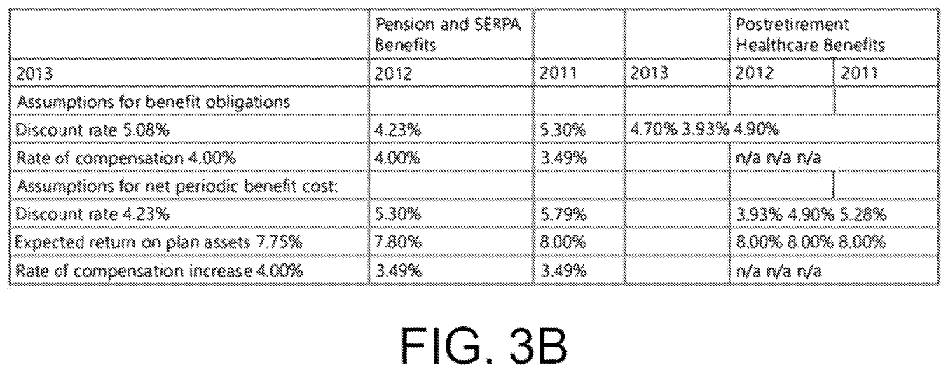

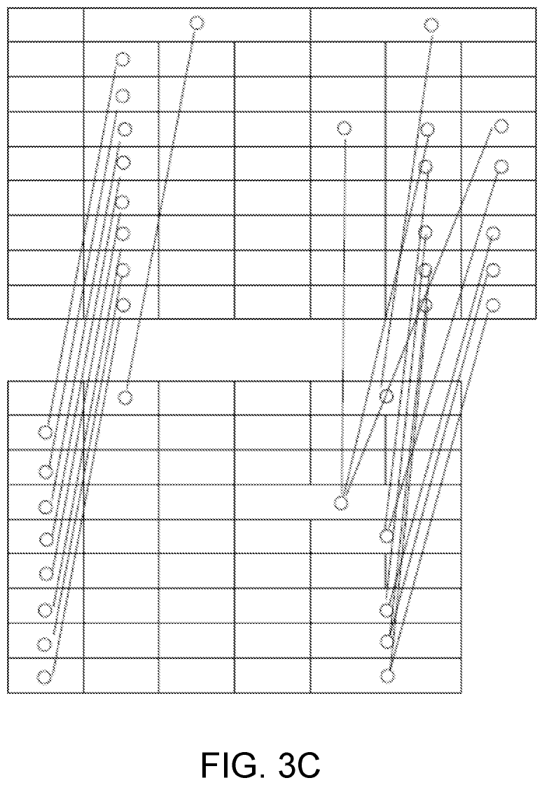

The following shows a visualization of the results. FIGS. 3A through 3C show how the methods of the present disclosure can match gold and prediction cells. FIGS. 3A through 3C provide an example of cell matching when the prediction includes many errors. The corresponding cells in gold and prediction tables are connected by lines in FIG. 3C, which shows that there are more errors in the row direction, and the prediction table has fewer columns. The table shows that some columns are merged incorrectly.

The methods of the present disclosure do not require one looking at the prediction and the correct tables. The tendency of errors can be identified by simply visualizing the correspondence matrices between cells. This is a significant advantage of table structure recognition evaluation using optimal transport.

Combining the optimal transport distance matrix with the edit distance matrix allows for more exact matching. FIGS. 4A through 4C show the matching of gold and prediction cells at each distance and their sum.

The optimal transport matching without considering cell contents cannot detect a missing row in the table. In addition, diagonal lines can be seen in FIG. 4C for matching based on edit distance only. This is a case where a pair of cells that are unlikely to be matched due to their structure are matched due to similar characters. Combining the optimal transport distance matrix with the edit distance matrix allows the correct recognition of the missing third row.

### Settings

A difference between TabOT and the two existing metrics, TEDS and GriTS, can be illustrated. Table structure recognition was performed with a table transformer model (TATR) and the results were compared for each evaluation metric. TATR uses a convolutional neural networks (CNN) and a transformer encoder-decoder to detect tables, rows, columns, and cells in the same way as object detection. FinTabNet was used and tables were sampled as an evaluation dataset.

As comparison methods, TEDS, which evaluates the tree structure of a table represented in HTML, and GriTS, which considers a table to be a matrix, were both used.

### Experiments on Sample Tables

First, the differences between the scores that TEDS and TabOT output for the sample tables are discussed. It can be shown how the two evaluation metrics perform for tables with one column or one row missing. For a 4×4 gold table, eight tables were prepared with one row or column missing, and the scores were measured. The TEDS score showed different values depending on whether it was a row or a column that was lost, but TaBOT showed the same values. Rows and columns should be treated equally when the number of cells is the same, and TaBOT behaves according to this principle.

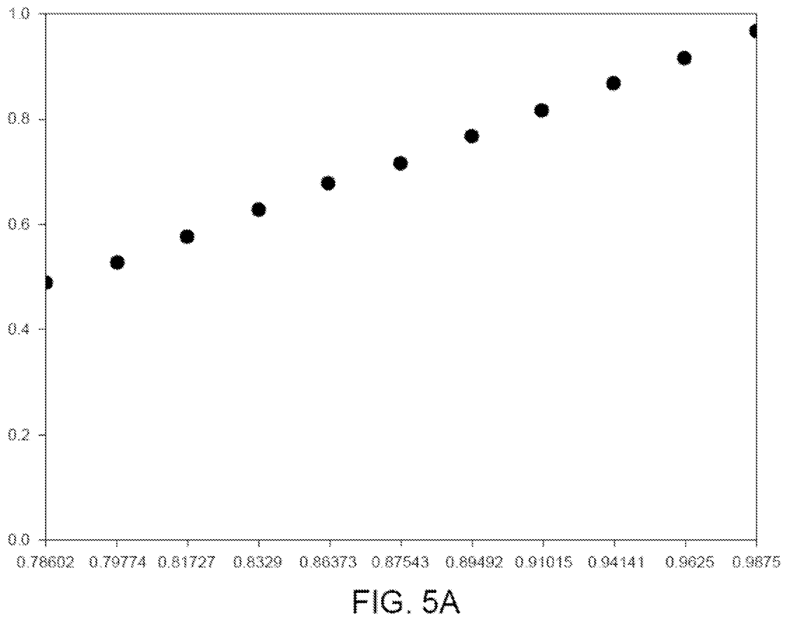

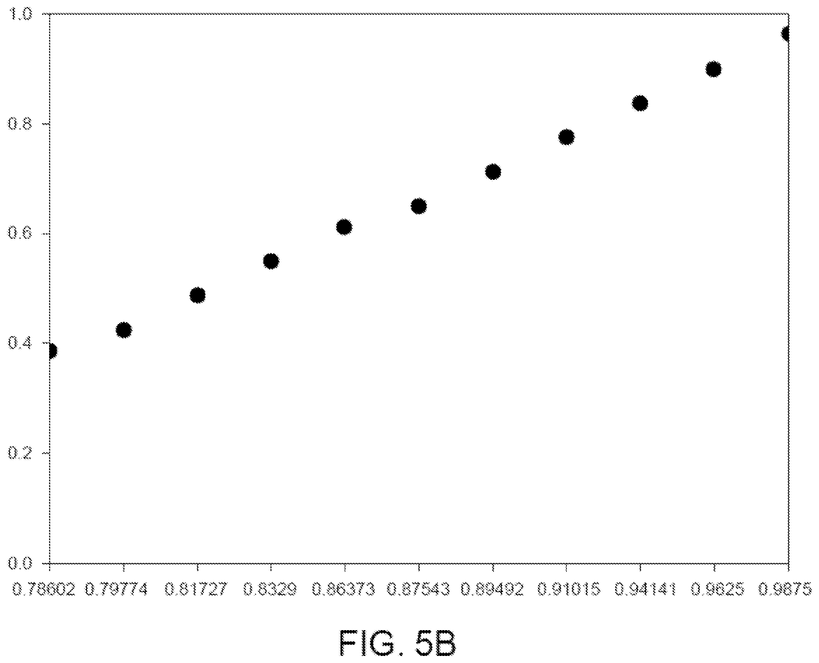

Next, the relationship between TabOT and TEDS/GriTS was described. Sixteen pairs of 4×4 tables were prepared and the n: 0<n<17 cell of the prediction table (pred) was changed to a value different from the gold table. FIGS. 5A and 5B shows the score of each table. Scores on TabOT and TEDS, TabOT and GriTS are positively correlated with each other. This indicates that TabOT is compatible with existing evaluation metrics.

### Experiments on FinTabNet

Table structure recognition was performed using FinTabNet as the dataset and TATR as the model. The results were evaluated using several metrics. TEDS, GriTS, and the method according to aspects of the present disclosure, TabOT, were used as evaluation metrics. The median and mean values are shown in Table 1.

TABLE 1
The median and mean values trained by TATR using FinTabNet
and measured by each evaluation metrics.

| Name | TEDS | GriTS | TabOT |
|---|---|---|---|
| Mean | 0.732 | 0.985 | 0.906 |
| Median | 0.791 | 1.000 | 0.932 |

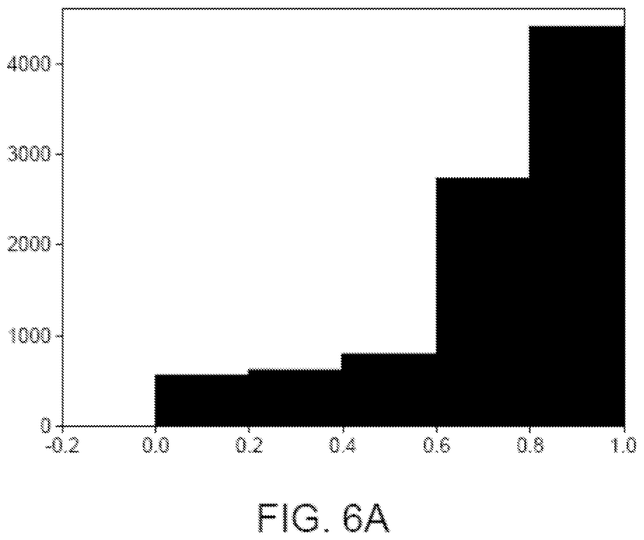

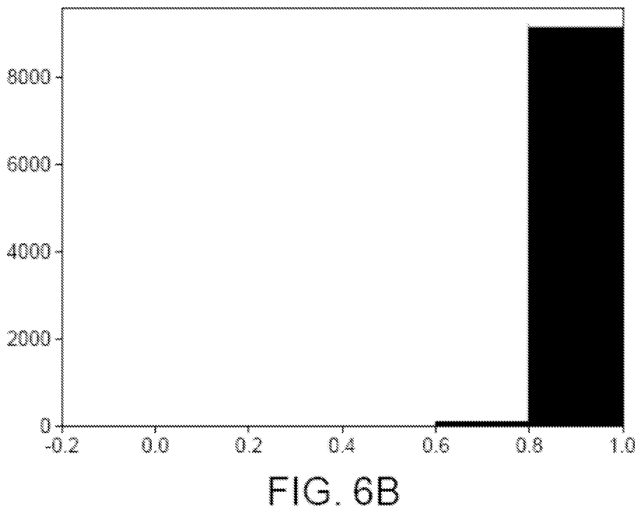

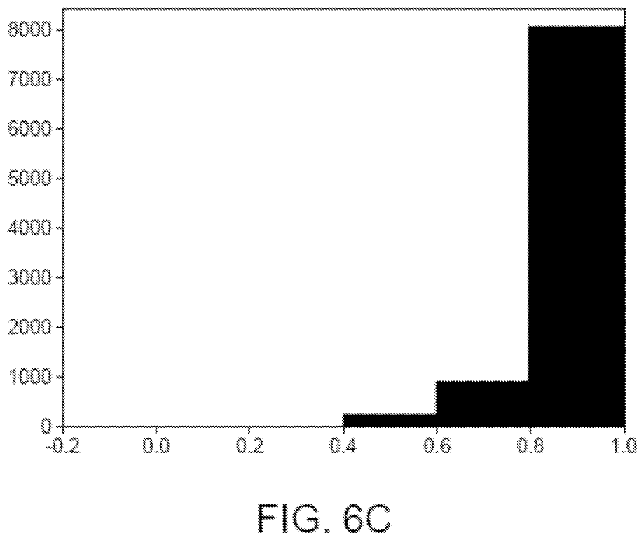

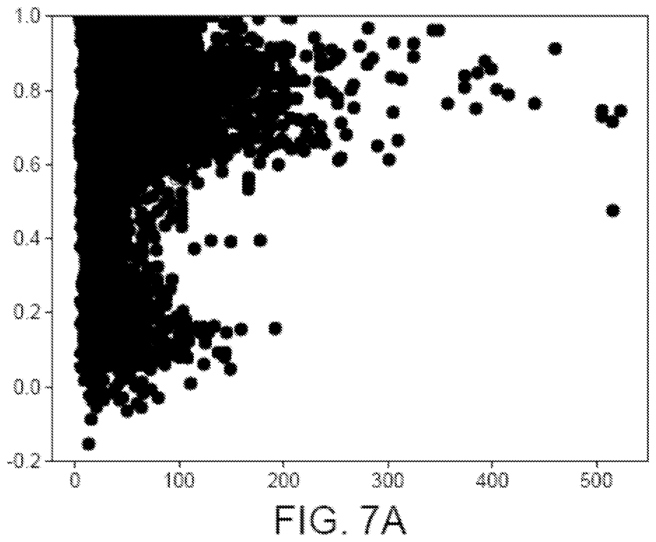

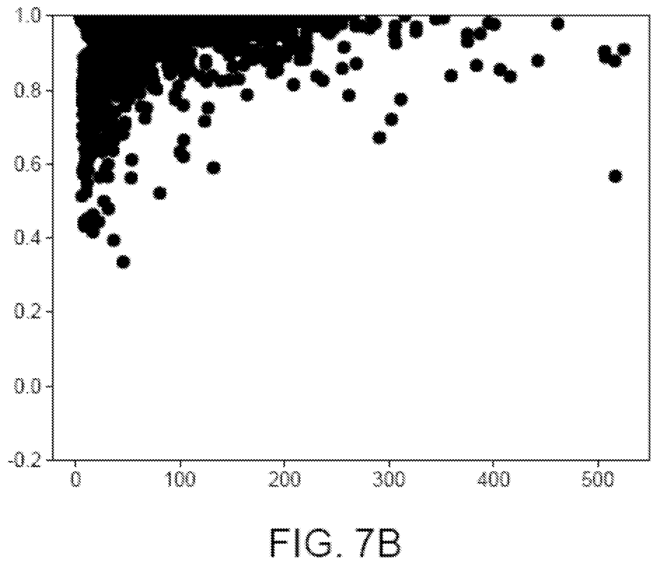

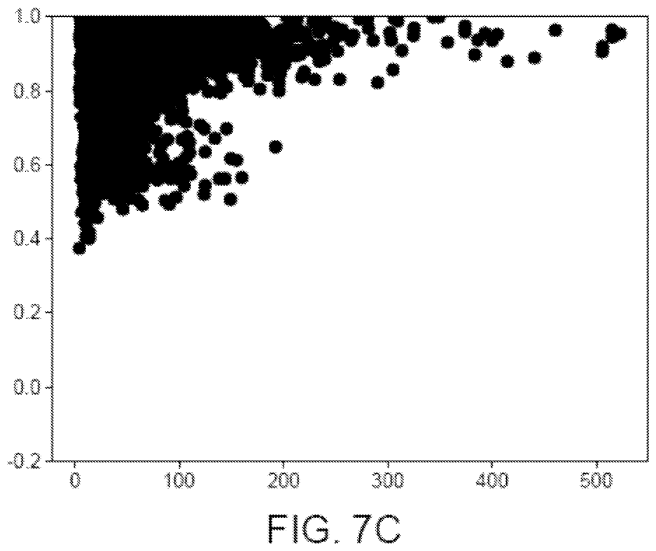

When evaluated by GriTS, most tables have scores of 0.9 or higher, making it difficult to compare the tables. The distributions of each metric are shown in FIGS. 6A and 6B. The scores according to the number of cells in the table are shown in the FIGS. 7A through 7C.

The symmetry of TabOT, i.e. the difference in scores when the gold table and the prediction table are replaced can be observed. In equation (2), above, the set of matrices Π^{u}(p, q) is bounded and defined by |p|+|q| equality constraints, therefore is a convex polytope. By using Kantrovich's relaxed formulation, which is always symmetric, in the sense that a coupling T is in Π^{u}(p, q) if and only if T^{T} isinΠ^{u}(p, q).

Thus, TabOT satisfies symmetry. The table evaluation metric calculates the similarity between two tables, therefore it is better to have symmetry.

### SUMMARY

A table structure evaluation metric, according to aspect of the present disclosure, visualizes the matching of table cells using optimal transport. It can be shown that 85% of the prediction and gold table cells are correctly matched and evaluated. The combined evaluation of edit distance matrix and optimal transport distance matrix enables cell matching with excellent accuracy.

The evaluation metric, according to aspects of the present disclosure, has the property that it can be used not only for evaluation but also as an objective function for retraining table structure recognition model, and can contribute to both performance improvement and correct evaluation.

### Example Process

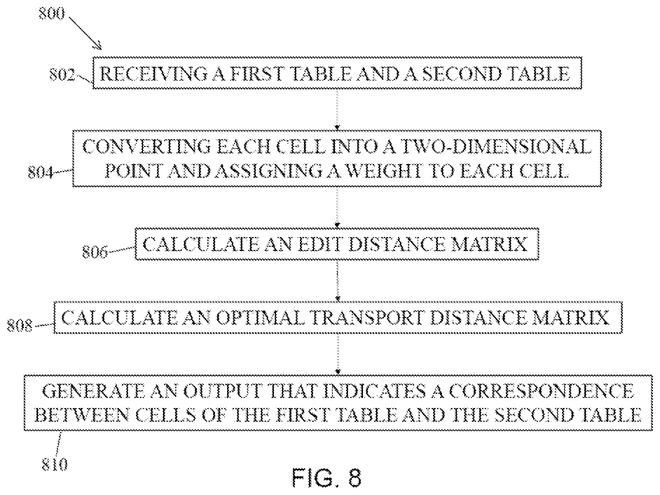

It may be helpful now to consider a high-level discussion of an example process. To that end, FIG. 8 presents an illustrative process related to the method for comparing tables. Process 800 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 8, act 802 of process 800, can include receiving a first table and a second table into a table evaluation system. In act 804, each of a plurality of cells of the first table and the second table are converted into a two-dimensional point with a cell weight related to the size of the cell. In act 805, an edit distance matrix between the cells of the first table and the cells of the second table is computed, where the edit distance matrix being obtained based on contents of cells. In act 808, an optimal transport distance matrix between the cells of the first table and the cells of the second table is computed by using the two-dimensional point and the cell weight for each of the plurality of cells. In act 810, an output is generated that indicates a correspondence between cells in the first table and cells in the second table by using the edit distance matrix and the optimal transport distance matrix.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

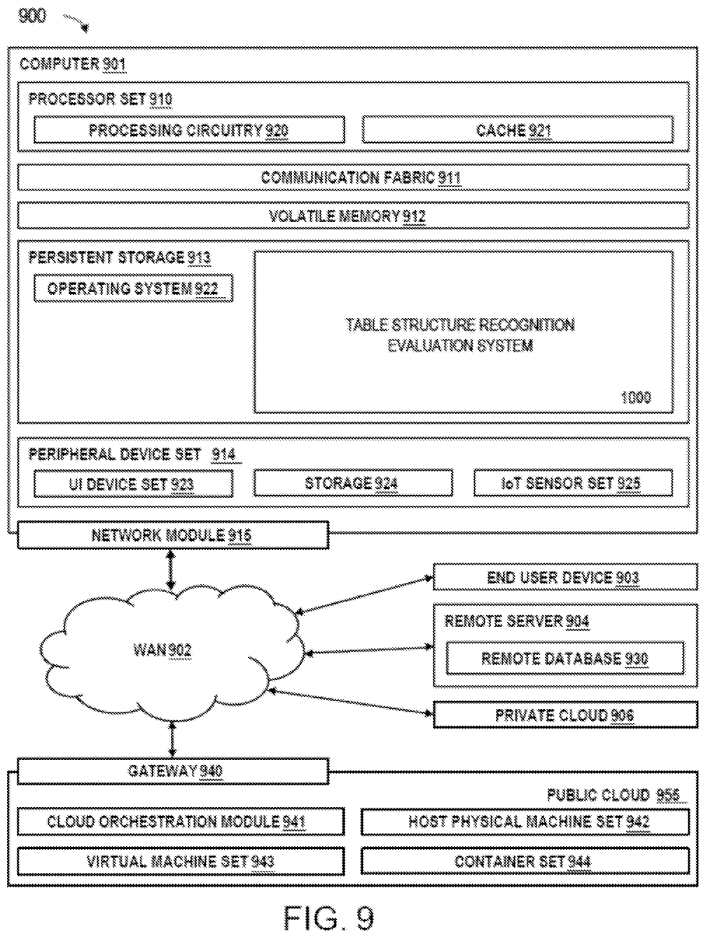

Referring to FIG. 9, computing environment 900 includes an example of an environment for the execution of at least some of the computer code involved in performing the inventive methods, including a table structure recognition system block 1000. In addition to block 1000, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 1000, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 1000 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 1000 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for comparing tables, comprising:
receiving a first table and a second table into a table evaluation system;
converting each of a plurality of cells of the first table and the second table into a two-dimensional point with a cell weight related to a size of the cell;
computing an edit distance matrix between the cells of the first table and the cells of the second table, the edit distance matrix being obtained based on contents of cells;
computing an optimal transport distance matrix between the cells of the first table and the cells of the second table by using the two-dimensional point and the cell weight for each of the plurality of cells; and
generating an output indicating a correspondence between the cells of the first table and the cells of the second table by using the edit distance matrix and the optimal transport distance matrix.

2. The computer-implemented method according to claim 1, further comprising:
calculating a ground overhead value indicating a degree of matching between the first table and the second table by using the optimal transport distance matrix and the edit distance matrix; and
outputting the ground overhead value.

3. The computer-implemented method according to claim 2, further comprising adjusting a parameter to determine a weighting ratio of the edit distance matrix to the optimal transport distance matrix used to calculate the ground overhead value.

4. The computer-implemented method according to claim 3, further comprising retraining a table structure recognition model based on the ground overhead value.

5. The computer-implemented method according to claim 1, further comprising:
calculating an evaluation metric indicating a degree of matching between the first table and the second table; and
outputting the evaluation metric.

6. The computer-implemented method according to claim 5, further comprising:
calculating a penalty for non-matching cells between the first table and the second table; and
including the penalty for the calculation of the evaluation metric.

7. The computer-implemented method according to claim 6, wherein the evaluation metric further depends on a partial Wasserstein distance.

8. The computer-implemented method according to claim 5, wherein the evaluation metric is a numerical value within a range from zero to one.

9. The computer-implemented method according to claim 1, wherein each of the cell weights is further related to an importance of each of the plurality of cells.

10. The computer-implemented method according to claim 1, further comprising extracting the first table from a document.

11. The computer-implemented method according to claim 10, further comprising operating a table structure recognition model on the extracted first table to generate a prediction table as the first table.

12. The computer-implemented method according to claim 11, wherein the second table is a ground truth table.

13. The computer-implemented method according to claim 12, further comprising retraining the table structure recognition model based on an evaluation metric indicating a degree of matching between the first table and the second table.

14. The computer-implemented method according to claim 1, wherein the optimal transport distance matrix is a Euclidean distance and the edit distance matrix is a Levenshtein distance.

15. The computer-implemented method according to claim 1, further comprising outputting a graphical representation illustrating a combined result of the optimal transport distance matrix and the edit distance matrix.

16. A computer-implemented method for evaluating a table structure recognition model comprising, comprising:
receiving a prediction table into a table structure recognition evaluation system by using the table structure recognition model;
receiving a ground truth table representing a ground truth of the prediction table;
converting each of a plurality of cells of the prediction table and the ground truth table into a two-dimensional point with a cell weight related to a size of the cell;
computing an edit distance matrix between the cells of the prediction table and the cells of the ground truth table, the edit distance matrix being obtained based on contents of cells;
computing an optimal transport distance matrix between the cells of the prediction table and the cells of the ground truth table by using the two-dimensional point and the cell weight for each of the plurality of cells; and
generating an output indicating a correspondence between the cells of the prediction table and the cells of the ground truth table by using the edit distance matrix and the optimal transport distance matrix.

17. The computer-implemented method according to claim 16, further comprising:
adjusting a parameter to determine a weighting ratio of the edit distance matrix to the optimal transport distance matrix used to calculate a ground overhead value;
calculating the ground overhead value to indicate a degree of matching between the prediction table and the ground truth table by using the parameter and by using the optimal transport distance matrix and the edit distance matrix; and
outputting the ground overhead value.

18. The computer-implemented method according to claim 17, further comprising:
calculating an evaluation metric indicating the degree of matching between the prediction table and the ground truth table; and
outputting the evaluation metric.

19. The computer-implemented method according to claim 18, further comprising:
calculating a penalty for non-matching cells between the prediction table and the ground truth table; and
including the penalty for the calculation of the evaluation metric.

20. The computer-implemented method according to claim 18, further comprising retraining the table structure recognition model based on the evaluation metric and/or the ground overhead value.

21. A computer-implemented method for providing a metric for an evaluation of a table structure recognition model, comprising:
receiving a prediction table into a table structure recognition evaluation system by using the table structure recognition model;
receiving a ground truth table representing a ground truth of the prediction table;
converting each of a plurality of cells of the prediction table and the ground truth table into a two-dimensional point with a cell weight related to a size of the cell;
computing an edit distance matrix between the cells of the prediction table and the cells of the ground truth table, the edit distance matrix being obtained based on contents of cells;
computing an optimal transport distance matrix between the cells of the prediction table and the cells of the ground truth table by using the two-dimensional point and the cell weight for each of the plurality of cells;
calculating a ground overhead value by using the optimal transport distance matrix and the edit distance matrix;
calculating an evaluation metric, based on the ground overhead value, indicating a degree of matching between the prediction table and the ground truth table; and
outputting the evaluation metric.

22. The computer-implemented method according to claim 21, further comprising adjusting a parameter to determine a weighting ratio of the edit distance matrix to the optimal transport distance matrix used to calculate the ground overhead value.

23. The computer-implemented method according to claim 21, further comprising retraining the table structure recognition model based on the evaluation metric and/or the ground overhead value.

24. A system comprising:
a processor;
a data bus coupled to the processor;
a memory coupled to the data bus; and
a computer-usable medium embodying a computer program code, the computer program code comprising instructions executable by the processor and configured to:
receive a first table and a second table into a table evaluation system;
convert each of a plurality of cells of the first table and the second table into a two-dimensional point with a cell weight related to a size of the cell;
compute an edit distance matrix between the cells of the first table and the cells of the second table, the edit distance matrix being obtained based on contents of cells;
compute an optimal transport distance matrix between the cells of the first table and the cells of the second table by using the two-dimensional point and the cell weight for each of the plurality of cells; and
generate an output indicating a correspondence between the cells of the first table and the cells of the second table by using the edit distance matrix and the optimal transport distance matrix.

25. A computer program product for evaluating a table structure recognition model, the computer program product comprising a computer readable storage medium having program instructions embodied therewith, wherein upon execution by a computer, the program instructions cause the computer to:
receive a prediction table into a table structure recognition evaluation system by using the table structure recognition model;
receive a ground truth table representing a ground truth of the prediction table;
convert each of a plurality of cells of the prediction table and the ground truth table into a two-dimensional point with a cell weight related to a size of the cell;
compute an edit distance matrix between the cells of the prediction table and the cells of the ground truth table, the edit distance matrix being obtained based on contents of cells;
compute an optimal transport distance matrix between the cells of the prediction table and the cells of the ground truth table by using the two-dimensional point and the cell weight for each of the plurality of cells; and
generate an output indicating a correspondence between the cells of the prediction table and the cells of the ground truth table by using the edit distance matrix and the optimal transport distance matrix.
